(19) United States
(12) Patent Application Publication
(10) Pub. No.: US 2025/0054123 A1
(43) Pub. Date: Feb. 13, 2025

(54) PRODUCT QUANTITY DETERMINATION APPARATUS, PRODUCT QUANTITY DETERMINATION METHOD, AND NON-TRANSITORY COMPUTER-READABLE STORAGE MEDIUM

(71) Applicant: NEC Corporation, Minato-ku, Tokyo (JP)

(72) Inventors: Soma Shiraishi, Tokyo (JP); Takami Sato, Tokyo (JP); Tomokazu Kaneko, Tokyo (JP)

(73) Assignee: NEC Corporation, Minato-ku, Tokyo (JP)

(21) Appl. No.: 18/723,548

(22) PCT Filed: Mar. 29, 2022
(86) PCT No.: PCT/JP2022/015464

§ 371 Date: Jun. 24, 2024

(51) Int. Cl. G06T 7/00

(52) U.S. Cl. CPC G06T 7/0002; G06T 2207/30242

(57) ABSTRACT

A product quantity determination apparatus includes an acquisition unit, an image processing unit, and a computation unit. The acquisition unit acquires a plurality of images. The images include, in a capturing range, a target region being a region where a product may be disposed. The image processing unit performs detection processing of a product on each of the plurality of images. The computation unit determines a first product being a product detected in a predetermined number or more of the images in the detection processing, and sets, as a quantity of products to be paid for, a quantity acquired by excluding the first product from products detected by the detection processing.

### TECHNICAL FIELD

The present invention relates to a product quantity determination apparatus, a product quantity determination method, and a storage medium.

### BACKGROUND ART

In recent years, it has been considered that an image of a product is acquired and processed when the payment for the product is made and the processing result is used. For example, Patent Document 1 describes a recognition system for recognizing a target article by using image processing.

The recognition system includes a first detection unit, an extraction unit, a computation unit, a recognition unit, and a selection unit. The first detection unit detects an article included in image data captured by a capturing unit. The extraction unit extracts a feature value of the article detected by the first detection unit from the image data. The computation unit computes a degree of similarity between a verification feature value being stored in advance for each article of an article provided with identification information and an article without the identification information, and the feature value extracted by the extraction unit. The recognition unit recognizes the article detected by the first detection unit, based on the degree of similarity. On a condition that the article recognized by the recognition unit is the article without the identification information, the selection unit selects the article as an article captured by the capturing unit.

Note that, Patent Document 2 describes that occurrence of false recognition in which a hand is recognized as a product can be reduced by registering, in advance, a feature value of a general-purpose exclusion article such as a hand and an arm in a dictionary file.

### RELATED DOCUMENT

### Patent Document

Patent Document 1: Japanese Patent Application Publication No. 2020-17876
Patent Document 2: Japanese Patent Application Publication No. 2018-101292

### SUMMARY OF INVENTION

### Technical Problem

The present inventors have considered that presence or absence of a possibility that a product is not accurately registered is decided by comparing a quantity of products which have been registered in a product registration apparatus and a quantity of products included in an image in which a region including the product registration apparatus is captured. However, when the processing is performed, a quantity of products included in an image needs to be accurately detected. However, in the recognition system described in Patent Document 1 described above, there is a possibility that a quantity of products cannot be accurately detected.

One example of an object of the present invention is, in view of the problem described above, to provide a product quantity determination apparatus, a product quantity determination method, and a storage medium that can accurately detect a quantity of products included in an image.

### Solution to Problem

One aspect of the present invention provides a product quantity determination apparatus including:
an acquisition unit that acquires a plurality of images including, in a capturing range, a target region being a region where a product may be disposed;
an image processing unit that performs detection processing of a product on each of the plurality of images; and
a computation unit that determines a first object being a product detected in a predetermined number or more of the images in the detection processing, and sets, as a first product quantity being a quantity of products to be paid for, a quantity acquired by excluding the first object from products detected by the detection processing.

Another aspect of the present invention provides a product quantity determination method including,
by a computer:
acquiring a plurality of images including, in a capturing range, a target region being a region where a product may be disposed;
performing detection processing of a product on each of the plurality of images; and
determining a first object being a product detected in a predetermined number or more of the images in the detection processing, and setting, as a first product quantity being a quantity of products to be paid for, a quantity acquired by excluding the first object from products detected by the detection processing.

Still another aspect of the present invention provides a computer-readable storage medium storing a program causing a computer to include:
an acquisition function of acquiring a plurality of images including, in a capturing range, a target region being a region where a product may be disposed;
an image processing function of performing detection processing of a product on each of the plurality of images; and
a computation function of determining a first object being a product detected in a predetermined number or more of the images in the detection processing, and setting, as a first product quantity being a quantity of products to be paid for, a quantity acquired by excluding the first object from products detected by the detection processing.

### Advantageous Effects of Invention

One aspect of the present invention can provide a product quantity determination apparatus, a product quantity determination method, and a storage medium that can accurately detect a quantity of products included in an image.

### BRIEF DESCRIPTION OF DRAWINGS

FIG. 1 It is a diagram illustrating an overview of a product quantity determination apparatus according to an example embodiment.

FIG. 2 It is diagram illustrating a usage environment of the product quantity determination apparatus.

FIG. 3 It is a diagram illustrating a first example of a capturing range of a capturing apparatus.

FIG. 4 It is a diagram illustrating a modification example of FIG. 3.

FIG. 5 It is a diagram illustrating a second example of a capturing range of the capturing apparatus.

FIG. 6 It is a diagram illustrating one example of a functional configuration of the product quantity determination apparatus.

FIG. 7 It is a diagram illustrating a hardware configuration example of the product quantity determination apparatus.

FIG. 8 It is a flowchart illustrating a first example of processing performed by the product quantity determination apparatus.

FIG. 9 It is a flowchart illustrating a second example of processing performed by the product quantity determination apparatus.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

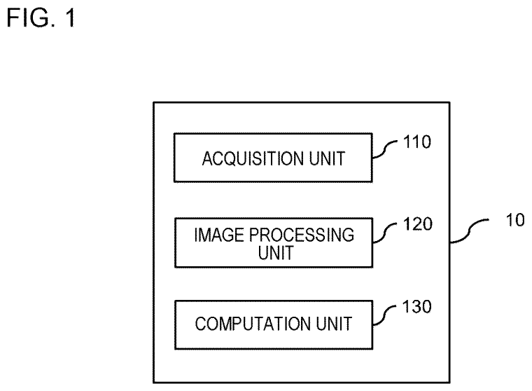

FIG. 1 is a diagram illustrating an overview of a product quantity determination apparatus 10 according to an example embodiment. The product quantity determination apparatus 10 includes an acquisition unit 110, an image processing unit 120, and a computation unit 130. The acquisition unit 110 acquires a plurality of images. The images include, in a capturing range, a target region being a region where a product may be disposed. The image processing unit 120 performs detection processing of a product on each of the plurality of images. The computation unit 130 determines a first object being a product detected in a predetermined number or more of the images in the detection processing, and sets, as a quantity of products to be paid for, a quantity acquired by excluding the first object from products detected by the detection processing. Hereinafter, the quantity of the products will be described as a first product quantity.

Since the first object is a product detected in the predetermined number or more of the images, the first object has a high possibility of not being a product to be paid for, such as a hand of a person and additional equipment of the product quantity determination apparatus 10. Thus, the computation unit 130 sets, as a quantity of products to be paid for, a quantity acquired by excluding the first object from products detected by the detection processing. Therefore, the product quantity determination apparatus 10 can accurately detect a quantity of products included in an image.

Hereinafter, a detailed example of the product quantity determination apparatus 10 will be described.

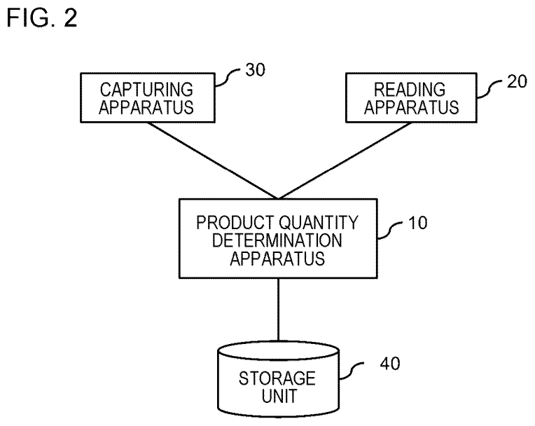

FIG. 2 is diagram illustrating a usage environment of the product quantity determination apparatus 10. In the example illustrated in FIG. 2, the product quantity determination apparatus 10 is used as an apparatus that performs registration and payment of a product. However, as described below, the product quantity determination apparatus 10 may be an apparatus different from an apparatus that performs registration and payment of a product, for example, a cloud server.

The product quantity determination apparatus 10 is installed at a store or an office. When the product quantity determination apparatus 10 is installed at a store, a customer who has entered the store operates the product quantity determination apparatus 10 when the customer purchases a product. On the other hand, when the product quantity determination apparatus 10 is installed at an office, a product is displayed in a part of the office. Then, a person who works at the office operates the product quantity determination apparatus 10 when the person purchases the product.

The product quantity determination apparatus 10 is used together with a reading apparatus 20, a capturing apparatus 30, and a storage unit 40. In the example illustrated in FIG. 2, the product quantity determination apparatus 10 is used when a customer purchases a product, and has a product registration function and a payment function. In other words, the product quantity determination apparatus 10 also functions as a product registration apparatus. Note that, the product quantity determination apparatus 10 does not have to have the payment function. In this case, the product quantity determination apparatus 10 transmits information indicating a registered product to a payment apparatus.

The reading apparatus 20 acquires product identification information from a product to be purchased by a customer, that is, a product to be paid for. The reading apparatus 20 may acquire product identification information by reading a code provided to a product, for example, reading a bar code or a two-dimensional code, and may acquire product identification information from a wireless communication tag provided to a product, for example, an RFID tag. The reading apparatus 20 transmits the acquired product identification information to the product quantity determination apparatus 10. At this time, the reading apparatus 20 also transmits information indicating an acquisition timing of the product identification information, for example, acquisition date and time information to the product quantity determination apparatus 10. Hereinafter, the information will be described as first timing information. The first timing information may be generated by the product quantity determination apparatus 10. In this case, the product quantity determination apparatus 10 generates the first timing information in such a way that the first timing information indicates a timing at which the product identification information is acquired from the reading apparatus 20.

Note that, the reading apparatus 20 may be integrated with the product quantity determination apparatus 10.

When the reading apparatus 20 acquires product identification information from a product, the capturing apparatus 30 captures the product and generates a first image. The capturing apparatus 30 may always generate an image, or may generate an image with, as a trigger, the reading apparatus 20 acquiring product identification information. A frame rate of the capturing apparatus 30 in the former case is, for example, equal to or more than 1 pfs and equal to or less than 30 pfs, which is not limited thereto.

Note that, the capturing apparatus 30 may be attached to the product quantity determination apparatus 10, or may be attached above the product quantity determination apparatus 10, for example, on a ceiling.

A capturing range of the capturing apparatus 30 includes a region where a product may be disposed when the reading apparatus 20 acquires product identification information, that is, a product reading region. The capturing range of the capturing apparatus 30 may include the reading apparatus 20. Further, the capturing range may include a region around the product reading region. In this case, the capturing range preferably includes at least one of a region through which a product passes when the product moves toward the product reading region and a region through which a product passes when the product moves out of the product reading region. Then, the capturing apparatus 30 transmits a generated image to the product quantity determination apparatus 10. At this time, the capturing apparatus 30 also transmits information indicating a generation timing of the image, for example, generation date and time information to the product quantity determination apparatus 10. Hereinafter, the information will be described as second timing information.

The storage unit 40 stores product identification information and a price for each of a plurality of products. The product quantity determination apparatus 10 uses information stored in the storage unit 40 when the product quantity determination apparatus 10 performs payment processing for a product. The storage unit 40 may be, for example, a server installed at a store where the product quantity determination apparatus 10 is disposed.

In the description above, the product quantity determination apparatus 10 is used when a product is purchased. However, the product quantity determination apparatus 10 may be used when a salesclerk displays a product on a product shelf.

Note that, the product quantity determination apparatus 10 does not have to perform registration processing or payment processing of a target product. In this case, the product quantity determination apparatus 10 is an apparatus, such as a cloud server, for example, different from a terminal that performs the registration processing and the payment processing, for example, a POS terminal. Then, the reading apparatus 20 communicates with the terminal. The product quantity determination apparatus 10 acquires, from the terminal, information indicating a quantity of products registered in the terminal, that is, a second product quantity.

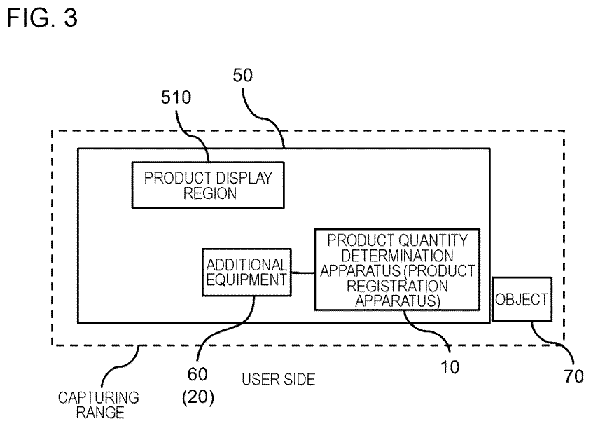

FIG. 3 is a diagram illustrating a first example of a capturing range of the capturing apparatus 30. In the example illustrated in FIG. 3, the product quantity determination apparatus 10 is used when a product is purchased, and is placed on a pedestal 50. The pedestal 50 is sufficiently larger than the product quantity determination apparatus 10, and a part of the pedestal 50 is a product display region 510.

As described by using FIG. 2, the capturing range of the capturing apparatus 30 includes a region where a product may be disposed. The region where a product may be disposed includes at least one of a region where a product is temporarily disposed and a region where a product is disposed when product identification information about the product is registered in the product quantity determination apparatus 10. The former example is a region of the pedestal 50 where a product is temporarily placed. The latter example is a region (space) where the reading apparatus 20 that reads product identification information from a product can read the product identification information.

In the example illustrated in FIG. 3, the capturing range of the capturing apparatus 30 may further include the product quantity determination apparatus 10 and the product display region 510. Note that, a product that may be registered in the product quantity determination apparatus 10 may also be displayed at a place other than the product display region 510.

On the pedestal 50, additional equipment 60 of the product quantity determination apparatus 10, for example, at least one of the reading apparatus 20 illustrated in FIG. 2, a short-range wireless communication apparatus that communicates with a portable terminal, and a receipt printing apparatus is often disposed. Further, an object 70 such as a trash can may be disposed around the pedestal 50. The capturing range includes a region where a product is disposed when the reading apparatus 20 reads product identification information, for example, the surface in front of the reading apparatus 20. Thus, a product whose product identification information is read by the reading apparatus 20 is included in an image generated by the capturing apparatus 30.

The capturing range of the capturing apparatus 30 may also include the additional equipment 60 and the object 70. In this case, the additional equipment 60 and the object 70 may be recognized as a product to be paid for by mistake. However, the additional equipment 60 and the object 70 rarely move, and are thus included in a plurality of images generated by the capturing apparatus 30. Thus, in the product quantity determination apparatus 10, the additional equipment 60 and the object 70 are recognized as the first object described above.

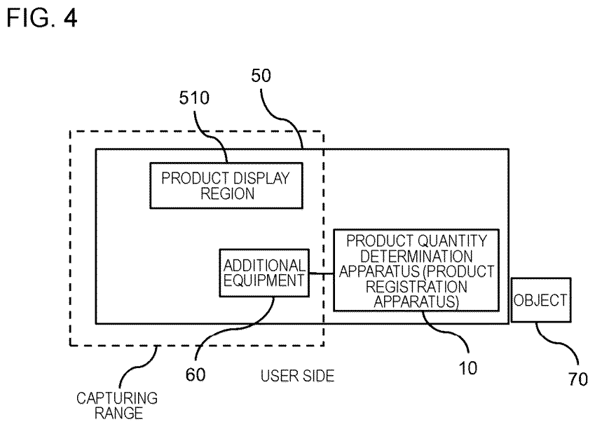

FIG. 4 is a diagram illustrating a modification example of FIG. 3. In the example illustrated in FIG. 4, a capturing range includes the product display region 510 and the additional equipment 60, but does not include the product quantity determination apparatus 10. In this way, the capturing range of the capturing apparatus 30 only has to include a region where a product may be disposed.

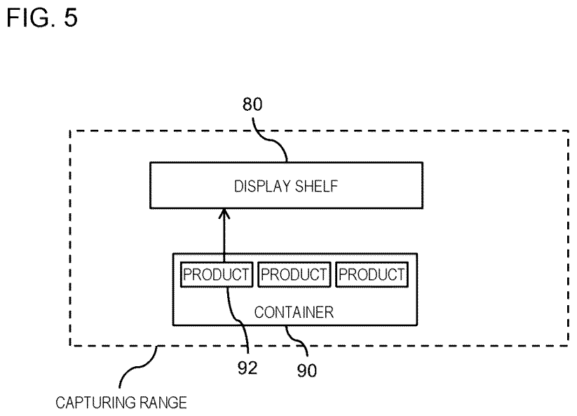

FIG. 5 is a diagram illustrating a second example of a capturing range of the capturing apparatus 30. In the example illustrated in FIG. 5, the product quantity determination apparatus 10 is used when a salesclerk takes out a product 92 from a container 90, for example, a folding container or a cardboard box, and displays the product 92 on a display shelf 80. In this case, the product quantity determination apparatus 10 determines a quantity of products displayed on the display shelf 80. In this example, the reading apparatus 20 is a portable apparatus operated by the salesclerk. However, the reading apparatus 20 may not be used in some cases.

In this example, the capturing range of the capturing apparatus 30 includes at least one or preferably both of the display shelf 80 and a region in front of the display shelf 80, that is, a place where the container 90 is disposed. Thus, the product 92 displayed on the display shelf 80 is included in an image generated by the capturing apparatus 30. The capturing apparatus 30 is a surveillance camera disposed in a store, but may be the other camera.

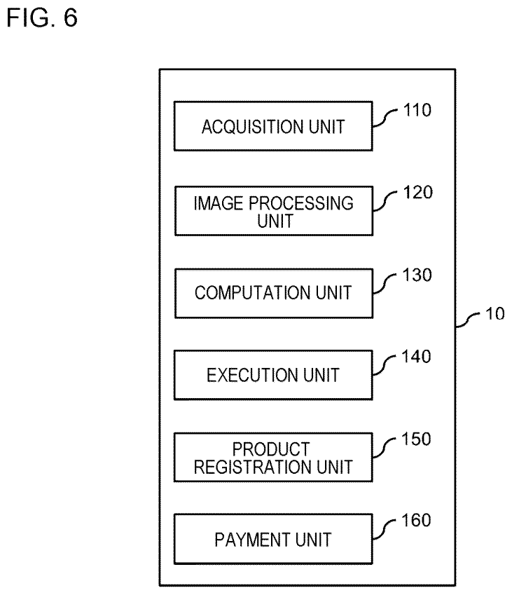

FIG. 6 is a diagram illustrating one example of a functional configuration of the product quantity determination apparatus 10. As described by using FIG. 1, the product quantity determination apparatus 10 includes the acquisition unit 110, the image processing unit 120, and the computation unit 130. In the example illustrated in FIG. 6, the product quantity determination apparatus 10 further includes an execution unit 140, a product registration unit 150, and a payment unit 160. Note that, when the product quantity determination apparatus 10 corresponds to the example illustrated in FIG. 5, the product quantity determination apparatus 10 does not include the product registration unit 150 or the payment unit 160.

The acquisition unit 110 acquires an image generated by the capturing apparatus 30. At this time, the acquisition unit 110 also acquires second timing information.

The image processing unit 120 performs detection processing of a product on each of a plurality of the images generated by the capturing apparatus 30. The image processing unit 120 may perform the detection processing of a product by using a model generated by machine learning, or may perform the detection processing of a product by feature value matching. Information needed when the image processing unit 120 performs the detection processing of a product is stored in, for example, the storage unit 40.

Then, the image processing unit 120 computes a total quantity of products to be paid for by using a result of the detection processing. Hereinafter, the total quantity of the products will be described as a first total quantity. At this time, the image processing unit 120 may track a product between a plurality of images, and determine the first total quantity by using the tracking result. Further, the image processing unit 120 may determine a quantity of products by kind of the products. Hereinafter, the quantity by the kind will be described as a first population quantity.

When the capturing apparatus 30 generates an image with, as a trigger, the reading apparatus 20 acquiring product identification information, an image acquired by the acquisition unit 110 is an image generated when the reading apparatus 20 reads the product identification information. Then, the image processing unit 120 preferably performs the detection processing of a product on all of a plurality of the images acquired by the acquisition unit 110.

On the other hand, when the capturing apparatus 30 is always operating, the image processing unit 120 may perform the detection processing of a product on all images, or may select an image that satisfies a predetermined condition as a target of the detection processing. An example of the “predetermined condition” is at least one of (1) to (4) below, for example.

### (1) Being an Image Having Second Timing Information Closest to First Timing Information

This example corresponds to the state illustrated in FIG. 3 or 4. An image selected herein includes a product associated with product identification information acquired by the acquisition unit 110. Herein, three cases where the first timing information and the second timing information indicate the same timing, the first timing information is earlier, and the second timing information is earlier are conceivable. In all of the cases, a difference between the first timing information and the second timing information is, for example, equal to or less than one second. When the reading apparatus 20 reads product identification information from each of a plurality of products, the acquisition unit 110 performs the selection processing of an image described above for each piece of the product identification information.

### (2) A Person Captured in an Image Using the Reading Apparatus 20

This example also corresponds to the state illustrated in FIG. 3 or 4. The image processing unit 120 performs detection processing of a person on an image. Then, when a person has been able to be detected and it is decided that the person causes the reading apparatus 20 to read product identification information, the image processing unit 120 performs product detection processing on the image.

(3) Being an Image Generated while a Product is Registered in the Product Quantity Determination Apparatus 10

This example also corresponds to the state illustrated in FIG. 3 or 4. Then, “while a product is registered in the product quantity determination apparatus 10” means, for example, a period of time since information indicating a registration start of a product in the product quantity determination apparatus 10 is input to the product quantity determination apparatus 10 until information indicating to proceed to payment processing is input to the product quantity determination apparatus 10. The image processing unit 120 determines, by using the second timing information, an image generated while a product is registered.

Note that, in (3), the image processing unit 120 may further add, to an image being a processing target, at least one of images generated before a product is registered in the product quantity determination apparatus 10. For example, the image processing unit 120 determines a time at which registration of a product starts. Then, an image generated from a predetermined period of time before the time, for example, 10 seconds before the time to the time is added to an image being a processing target. The reason is that these images are more likely to capture a first object.

(4) Being an Image Generated when a Salesclerk Performs Work for Disposing a Product on a Display Shelf

This example corresponds to the state illustrated in FIG. 5. The image processing unit 120 performs detection processing of a salesclerk on an image. Then, when a salesclerk has been able to be detected and it is decided that the salesclerk displays the product 92 on the display shelf 80, the image processing unit 120 performs product detection processing on the image.

The product registration unit 150 acquires product identification information from the reading apparatus 20. At this time, the product registration unit 150 also acquires first timing information. Registration information indicating a product to be paid for is generated by the product registration unit 150. The registration information includes a list of pieces of product identification information about products to be paid for, information indicating a total quantity of the products to be paid for, and information indicating a quantity of products by the product. Hereinafter, the total quantity of the products based on the registration information will be described as a second product quantity. Further, the quantity of the products by the product based on the registration information will be described as a second population quantity.

As described by using FIG. 1, the computation unit 130 determines a first object, that is, a product detected in a predetermined number or more images in the detection processing. The predetermined number is, for example, equal to or more than three and preferably equal to or more than five, but is not limited to the values. Then, the computation unit 130 sets, as a first product quantity, that is, a quantity of products to be paid for, a quantity acquired by excluding a quantity of the first object from a first total quantity computed by the image processing unit 120.

Herein, when a plurality of products are detected in at least one of the images, the computation unit 130 may determine the first object by deciding whether each of the plurality of products is detected in the other images. When a plurality of products are detected in one image, there is a possibility that at least one of the plurality of products is an object other than a product. The possibility is high particularly when a capturing range of the capturing apparatus 30 is narrow to some extent and slightly larger than a product reading region of the reading apparatus 20, for example, equal to or more than one time and equal to or less than two times. Thus, the computation unit 130 stores a feature value of each of the plurality of detected products in the storage unit 40, and sets each of the products having the feature value as a candidate for the first object. Then, the computation unit 130 determines the number of images including the candidate for the first object among the other images, and decides whether the candidate for the first object is actually the first object by using the number.

For example, when the number is great, the candidate frequently appears in the capturing range of the capturing apparatus 30. In this case, this candidate has a high possibility of not being actually a product to be purchased by a customer, for example, being a product or an apparatus placed around. Thus, when the number described above, that is, the number of images including the candidate for the first object among the other images is equal to or more than a reference value, the computation unit 130 decides the candidate as an object other than a product, that is, the first object. Note that, the reference value is, for example, two, but may be equal to or more than three, or may be one.

Note that, the image processing unit 120 may store, for each of a plurality of images, a feature value of a product detected in the image in the storage unit 40. In this case, the computation unit 130 provides, to a feature value associated with the candidate for the first object, a flag indicating that the feature value is associated with the candidate.

Further, when the image processing unit 120 computes, by kind of product, a quantity of the products, that is, a first population quantity, the computation unit 130 may perform at least one of pieces of processing indicated by (A) and (B) below.

(A) The computation unit 130 handles, as a first object, a product having a first population quantity greater than a maximum value of a second population quantity, and computes a first product quantity.

As described above, the second population quantity is computed based on product identification information registered in the product registration unit 150, and indicates a quantity of products by the products. Herein, when there is a product having the first population quantity greater than a maximum value of the second population quantity, the product has a high possibility of not being actually a product. Specifically, the product having the first population quantity has a high possibility of being a hand of a person or being the additional equipment 60 or the object 70 illustrated in FIG. 3. Thus, when the computation unit 130 computes a product quantity, the computation unit 130 handles the product having the first population quantity as the first object, that is, an object different from a product.

For example, it is assumed that the image processing unit 120 decides “the quantity of products A is two”, “the quantity of products B is three”, and “the quantity of products C is one”, and registration information generated by the product registration unit 150 indicates “the quantity of rice balls is two”, and “the quantity of plastic bottles of green tea is one”. In this case, a maximum value of a second population quantity is “two” being the quantity of rice balls. Meanwhile, the quantity of “product B” detected in the image processing unit 120 is three and greater than the maximum value of the second population quantity. In this case, the computation unit 130 handles “product B” as an object different from a product, and subtracts “three” being the quantity of “product B” from a first total quantity.

(B) When for any second population quantity, a kind of a first product having the second population quantity is fewer than a kind of a second product having a first population quantity same as the second population quantity, the computation unit 130 subtracts, from a quantity of products detected by the detection processing, that is, a first total quantity, a value acquired by multiplying a difference in number between the kind of the first product and the kind of the second product by the second population quantity.

For example, it is assumed that the image processing unit 120 decides “the quantity of products A is two”, “the quantity of products B is two”, the quantity of “products C is one”, and “the quantity of products D is one”, and registration information generated by the product registration unit 150 indicates “the quantity of rice balls is two”, “the quantity of bread is one”, and “the quantity of plastic bottles of green tea is one”. In this case, although a product having a quantity of two is one kind, products having a quantity of two are two kinds in the processing result of the image processing unit 120. In this case, one of the products of the two kinds has a high possibility of not being actually a product. Thus, the computation unit 130 subtracts, from the first total quantity, a value acquired by multiplying “one” being a “difference in number between the kind of the first product and the kind of the second product” by “two” being the second population quantity, that is, “two”.

When a difference between a second product quantity being a total quantity of products registered by the product registration unit 150 and a first product quantity computed by the computation unit 130 is equal to or more than a reference value, the execution unit 140 performs predetermined processing. The reference value is, for example, one, but may be equal to or more than two. The difference being equal to or more than the reference value indicates a possibility that the total quantity of the products registered by the product registration unit 150 and a total quantity of products to be purchased by a customer and a person who works at an office are different. Then, one example of the predetermined processing is output processing of warning information. The execution unit 140 may output the warning information to a display and a speaker included in the product quantity determination apparatus 10, or may output the warning information to a terminal operated by a manager who manages sales of products, for example, a terminal operated by a salesclerk at a store.

When the execution unit 140 does not perform the predetermined processing, that is, when there is a high possibility that the total quantity of the products registered by the product registration unit 150 and the total quantity of the products to be purchased by the customer and the person who works at the office coincide with each other, the payment unit 160 performs payment processing by using registration information generated by the product registration unit 150, that is, a list of pieces of product identification information about products to be paid for. At this time, the payment unit 160 uses information stored in the storage unit 40.

Note that, when the product quantity determination apparatus 10 is used as an apparatus, such as a cloud server, different from an apparatus that performs registration and payment of a product, the product quantity determination apparatus 10 does not include the product registration unit 150 or the payment unit 160. In this case, in addition to the product quantity determination apparatus 10, an apparatus including the product registration unit 150 and the payment unit 160, for example, a POS terminal is disposed in a position of the product quantity determination apparatus 10 in FIG. 3 or 4, for example. Hereinafter, the apparatus will be described as a registration payment apparatus. Then, the product quantity determination apparatus 10 acquires information indicating a second population quantity and a second product quantity from the registration payment apparatus. The execution unit 140 of the product quantity determination apparatus 10 transmits, to the registration payment apparatus, information indicating whether a difference between the second product quantity and a first product quantity is equal to or more than a reference value. When the difference between the second product quantity and the first product quantity is equal to or more than the reference value, the registration payment apparatus displays predetermined information on a display of the registration payment apparatus and outputs the predetermined information from a speaker of the registration payment apparatus.

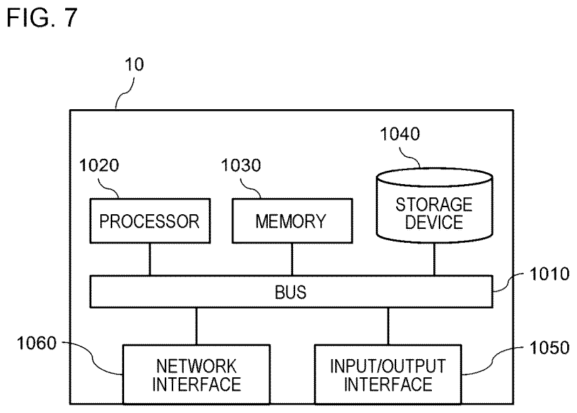

FIG. 7 is a diagram illustrating a hardware configuration example of the product quantity determination apparatus 10. The product quantity determination apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to one another is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a removable medium such as a memory card, a read only memory (ROM), or the like, and includes a storage medium. The storage medium of the storage device 1040 stores a program module that achieves each function (for example, the acquisition unit 110, the image processing unit 120, the computation unit 130, the execution unit 140, the product registration unit 150, and the payment unit 160) of the product quantity determination apparatus 10. The processor 1020 reads each program module onto the memory 1030 and executes the program module, and each function associated with the program module is achieved. Further, the storage device 1040 may also function as the storage unit 40.

The input/output interface 1050 is an interface for connecting the product quantity determination apparatus 10 and various types of input/output equipment. For example, the product quantity determination apparatus 10 communicates with at least one of the reading apparatus 20, the capturing apparatus 30, and the storage unit 40 via the input/output interface 1050.

The network interface 1060 is an interface for connecting the product quantity determination apparatus 10 to a network. The network is, for example, a local area network (LAN) and a wide area network (WAN). A method of connection to the network by the network interface 1060 may be wireless connection or wired connection. The product quantity determination apparatus 10 may communicate with at least one of the capturing apparatus 30 and the storage unit 40 via the network interface 1060.

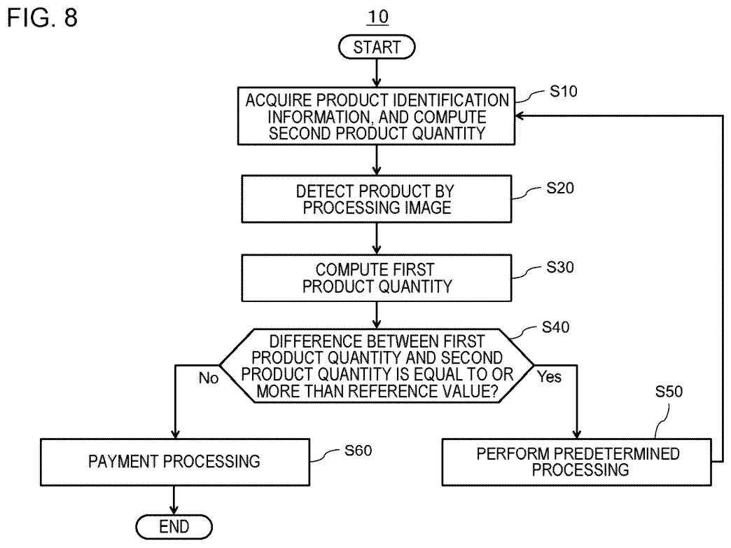

FIG. 8 is a flowchart illustrating a first example of processing performed by the product quantity determination apparatus 10. FIG. 8 corresponds to the example illustrated in FIG. 3.

When a customer and a person who works at an office purchase a product, they cause the reading apparatus 20 to read product identification information about the product. The product registration unit 150 of the product quantity determination apparatus 10 acquires the product identification information. When there are a plurality of products to be purchased, the product registration unit 150 acquires product identification information about each of the plurality of products. Then, the product registration unit 150 computes a second product quantity (step S10).

Further, the acquisition unit 110 acquires a plurality of images generated by the capturing apparatus 30. Then, the image processing unit 120 detects a product included in each of the plurality of images by processing the plurality of images (step S20). A specific example of the processing performed herein is as described by using FIG. 6.

Then, the computation unit 130 computes a first product quantity by using a processing result of the image processing unit 120 (step S30). A specific example of the processing performed herein is as described by using FIG. 6.

Then, when a difference between the second product quantity and the first product quantity is equal to or more than a reference value (step S40: Yes), the execution unit 140 performs predetermined processing (step S50). One example of the predetermined processing is warning processing. Subsequently, the product quantity determination apparatus 10 returns to step S10.

On the other hand, when a difference between the second product quantity and the first product quantity is less than the reference value (step S40: No), the payment unit 160 performs payment processing (step S60).

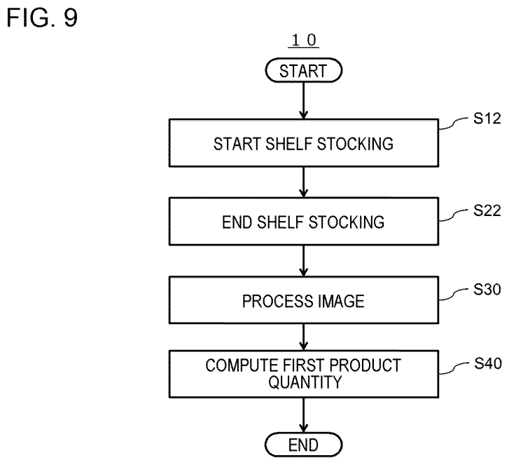

FIG. 9 is a flowchart illustrating a second example of processing performed by the product quantity determination apparatus 10. FIG. 9 corresponds to the example illustrated in FIG. 5.

A salesclerk of a store moves the container 90 close to the display shelf 80, and starts shelf stocking (step S12). Specifically, the salesclerk takes out the product 92 from the container 90, and displays the product 92 on the display shelf 80. The capturing apparatus 30 repeatedly generates an image while the salesclerk performs shelf stocking. The acquisition unit 110 acquires the images.

When shelf stocking ends (step S22), the image processing unit 120 processes the images acquired by the acquisition unit 110, and detects a product included in each of the plurality of images (step S30). A specific example of the processing performed herein is as described by using FIG. 6.

Then, the computation unit 130 computes a first product quantity by using a processing result of the image processing unit 120 (step S40). A specific example of the processing performed herein is as described by using FIG. 6.

As described above, according to the present example embodiment, the image processing unit 120 detects a product by processing an image. Then, the computation unit 130 determines a product detected in a predetermined number or more images in the detection processing performed by the image processing unit 120, that is, a first object. The first object has a high possibility of not being a product, such as a hand of a person and the additional equipment 60. Thus, the computation unit 130 sets, as a first product quantity being a quantity of products to be paid for, a quantity acquired by excluding the first object from products detected by the detection processing. Therefore, when the product quantity determination apparatus 10 is used, a quantity of products included in an image can be accurately detected.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, at least one of steps may be performed by another action subject, for example, another apparatus or person. Further, each of the example embodiments described above can be combined within an extent that a content is not inconsistent.

A part or the whole of the above-described example embodiment may also be described in supplementary notes below, which is not limited thereto.

1. A product quantity determination apparatus including:
an acquisition unit that acquires a plurality of images including, in a capturing range, a target region being a region where a product may be disposed;
an image processing unit that performs detection processing of a product on each of the plurality of images; and
a computation unit that determines a first object being a product detected in a predetermined number or more of the images in the detection processing, and sets, as a first product quantity being a quantity of products to be paid for, a quantity acquired by excluding the first object from products detected by the detection processing.
   2. The product quantity determination apparatus according to supplementary note 1 described above, in which the image processing unit performs the detection processing on the image that satisfies a predetermined condition.
   3. The product quantity determination apparatus according to supplementary note 2 described above, in which
the predetermined condition is that a person captured in the image uses a reading apparatus that reads product identification information.
   4. The product quantity determination apparatus according to supplementary note 2 described above, in which
the predetermined condition is that the image is generated when a salesclerk performs work for disposing the product on a display shelf.
   5. The product quantity determination apparatus according to any one of supplementary notes 1 to 4 described above, in which
the capturing range includes at least one of a display shelf of a product and a region in front of the display shelf.
   6. The product quantity determination apparatus according to any one of supplementary notes 1 to 4 described above, in which
the capturing range includes a region where a product is disposed when the product is registered in a product registration apparatus.
   7. The product quantity determination apparatus according to supplementary note 6 described above, in which
the image processing unit performs the detection processing on the plurality of images generated while the product is registered in the product registration apparatus.
   8. The product quantity determination apparatus according to supplementary note 7 described above, in which
the image processing unit further performs the detection processing on at least one of the images generated before the product is registered in the product registration apparatus.
   9. The product quantity determination apparatus according to supplementary note 7 or 8 described above, further including
an execution unit that performs predetermined processing when a difference between a second product quantity being a quantity of the products registered in the product registration apparatus and the first product quantity is equal to or more than a reference value.
   10. The product quantity determination apparatus according to any one of supplementary notes 7 to 9 described above, in which
the image processing unit computes a first population quantity being a quantity of the products by kind of the product,
the product registration apparatus computes a second population quantity being a quantity of the products by kind of the product, and
the computation unit computes the first product quantity by regarding, as the first object, the product having the first population quantity greater than a maximum value of the second population quantity.
   11. The product quantity determination apparatus according to any one of supplementary notes 7 to 9 described above, in which
the image processing unit computes a first population quantity being a quantity of the products by kind of the product,
the product registration apparatus computes a second population quantity being a quantity of the products by kind of the product, and,
at a time at which the computation unit computes the first product quantity,
when for any second population quantity, a kind of a first product having the second population quantity is fewer than a kind of a second product having the first population quantity same as the second population quantity, the computation unit subtracts, from a quantity of products detected by the detection processing, a value acquired by multiplying a difference in number between the kind of the first product and the kind of the second product by the second population quantity.
   12. The product quantity determination apparatus according to any one of supplementary notes 1 to 11 described above, in which,
when a plurality of products are detected in at least one of the images, the computation unit determines the first object by deciding whether each of the plurality of products is detected in the other image.
   13. A product quantity determination method including,
by a computer:
acquiring a plurality of images including, in a capturing range, a target region being a region where a product may be disposed;
performing detection processing of a product on each of the plurality of images; and
determining a first object being a product detected in a predetermined number or more of the images in the detection processing, and setting, as a first product quantity being a quantity of products to be paid for, a quantity acquired by excluding the first object from products detected by the detection processing.
   14. The product quantity determination method according to supplementary note 13 described above, in which
by the computer,
the detection processing is performed on the image that satisfies a predetermined condition.
   15. The product quantity determination method according to supplementary note 14 described above, in which
the predetermined condition is that a person captured in the image uses a reading apparatus that reads product identification information.
   16. The product quantity determination method according to supplementary note 14 described above, in which
the predetermined condition is that the image is generated when a salesclerk performs work for disposing the product on a display shelf.
   17. The product quantity determination method according to any one of supplementary notes 13 to 16 described above, in which
the capturing range includes at least one of a display shelf of a product and a region in front of the display shelf.
   18. The product quantity determination method according to any one of supplementary notes 13 to 16 described above, in which
the capturing range includes a region where a product is disposed when the product is registered in a product registration apparatus.
   19. The product quantity determination method according to supplementary note 18 described above, in which
by the computer,
the detection processing is performed on the plurality of images generated while the product is registered in the product registration apparatus.
   20. The product quantity determination method according to supplementary note 19 described above, in which
by the computer,
the detection processing is further performed on at least one of the images generated before the product is registered in the product registration apparatus.
   21. The product quantity determination method according to supplementary note 19 or 20 described above, further including, by the computer, performing predetermined processing when a difference between a second product quantity being a quantity of the products registered in the product registration apparatus and the first product quantity is equal to or more than a reference value.
   22. The product quantity determination method according to any one of supplementary notes 19 to 21 described above, further including:
by the computer, computing a first population quantity being a quantity of the products by kind of the product;
by the product registration apparatus, computing a second population quantity being a quantity of the products by kind of the product; and
by the computer, computing the first product quantity by regarding, as the first object, the product having the first population quantity greater than a maximum value of the second population quantity.
   23. The product quantity determination method according to any one of supplementary notes 19 to 21 described above, further including:
by the computer, computing a first population quantity being a quantity of the products by kind of the product;
by the product registration apparatus, computing a second population quantity being a quantity of the products by kind of the product; and,
at a time at which the computer computes the first product quantity, by the computer,
when for any second population quantity, a kind of a first product having the second population quantity is fewer than a kind of a second product having the first population quantity same as the second population quantity, by the computer, subtracting, from a quantity of products detected by the detection processing, a value acquired by multiplying a difference in number between the kind of the first product and the kind of the second product by the second population quantity.
   24. The product quantity determination method according to any one of supplementary notes 13 to 23 described above, in which
when a plurality of products are detected in at least one of the images, by the computer, the first object is determined by deciding whether each of the plurality of products is detected in the other image.
   25. A computer-readable storage medium storing a program causing a computer to include:
an acquisition function of acquiring a plurality of images including, in a capturing range, a target region being a region where a product may be disposed;
an image processing function of performing detection processing of a product on each of the plurality of images; and
a computation function of determining a first object being a product detected in a predetermined number or more of the images in the detection processing, and setting, as a first product quantity being a quantity of products to be paid for, a quantity acquired by excluding the first object from products detected by the detection processing.
   26. The storage medium according to supplementary note 25 described above, in which
the image processing function performs the detection processing on the image that satisfies a predetermined condition.
   27. The storage medium according to supplementary note 26 described above, in which
the predetermined condition is that a person captured in the image uses a reading apparatus that reads product identification information.
   28. The storage medium according to supplementary note 26 described above, in which
the predetermined condition is that the image is generated when a salesclerk performs work for disposing the product on a display shelf.
   29. The storage medium according to any one of supplementary notes 25 to 28 described above, in which
the capturing range includes at least one of a display shelf of a product and a region in front of the display shelf.
   30. The storage medium according to any one of supplementary notes 25 to 28 described above, in which
the capturing range includes a region where a product is disposed when the product is registered in a product registration apparatus.
   31. The storage medium according to supplementary note 30 described above, in which
the image processing function performs the detection processing on the plurality of images generated while the product is registered in the product registration apparatus.
   32. The storage medium according to supplementary note 31 described above, in which
the image processing function further performs the detection processing on at least one of the images generated before the product is registered in the product registration apparatus.
   33. The storage medium according to supplementary note 31 or 32 described above, the program further causing the computer to include
an execution function of performing predetermined processing when a difference between a second product quantity being a quantity of the products registered in the product registration apparatus and the first product quantity is equal to or more than a reference value.
   34. The storage medium according to any one of supplementary notes 31 to 33 described above, in which
the image processing function computes a first population quantity being a quantity of the products by kind of the product,
the product registration apparatus computes a second population quantity being a quantity of the products by kind of the product, and
the computation function computes the first product quantity by regarding, as the first object, the product having the first population quantity greater than a maximum value of the second population quantity.
   35. The storage medium according to any one of supplementary notes 31 to 33 described above, in which
the image processing function computes a first population quantity being a quantity of the products by kind of the product,
the product registration apparatus computes a second population quantity being a quantity of the products by kind of the product, and,
at a time at which the computation function computes the first product quantity,
when for any second population quantity, a kind of a first product having the second population quantity is fewer than a kind of a second product having the first population quantity same as the second population quantity, the computation function subtracts, from a quantity of products detected by the detection processing, a value acquired by multiplying a difference in number between the kind of the first product and the kind of the second product by the second population quantity.
   36. The storage medium according to any one of supplementary notes 25 to 35 described above, in which,
when a plurality of products are detected in at least one of the images, the computation function determines the first object by deciding whether each of the plurality of products is detected in the other image.
   37. The program according to any one of supplementary notes 25 to 36 described above.

### REFERENCE SIGNS LIST

10 Product quantity determination apparatus
20 Reading apparatus
30 Capturing apparatus
40 Storage unit
110 Acquisition unit
120 Image processing unit
130 Computation unit
140 Execution unit
150 Product registration unit
160 Payment unit

What is claimed is:

1. A product quantity determination apparatus comprising:
at least one memory configured to store instructions; and
at least one processor configured to execute the instructions to perform operations comprising:
acquiring a plurality of images including, in a capturing range, a target region being a region where a product may be disposed;
performing detection processing of a product on each of the plurality of images; and
determining a first object being a product detected in a predetermined number or more of the images in the detection processing, and setting, as a first product quantity being a quantity of products to be paid for, a quantity acquired by excluding the first object from products detected by the detection processing.

2. The product quantity determination apparatus according to claim 1, wherein the operations comprise:
performing the detection processing on the image that satisfies a predetermined condition.

3. The product quantity determination apparatus according to claim 2, wherein
the predetermined condition is that a person captured in the image uses a reading apparatus that reads product identification information.

4. The product quantity determination apparatus according to claim 2, wherein
the predetermined condition is that the image is generated when a salesclerk performs work for disposing the product on a display shelf.

5. The product quantity determination apparatus according to claim 1, wherein
the capturing range includes at least one of a display shelf of a product and a region in front of the display shelf.

6. The product quantity determination apparatus according to claim 1, wherein
the capturing range includes a region where a product is disposed when the product is registered in a product registration apparatus.

7. The product quantity determination apparatus according to claim 6, wherein
the operations comprise performing the detection processing on the plurality of images generated while the product is registered in the product registration apparatus.

8. The product quantity determination apparatus according to claim 7, wherein
the operations comprise further performing the detection processing on at least one of the images generated before the product is registered in the product registration apparatus.

9. The product quantity determination apparatus according to claim 7, wherein the operations further comprise
performing predetermined processing when a difference between a second product quantity being a quantity of the products registered in the product registration apparatus and the first product quantity is equal to or more than a reference value.

10. The product quantity determination apparatus according to claim 7, wherein the operations comprise
computing a first population quantity being a quantity of the products by kind of the product,
acquiring a second population quantity being a quantity of the products by kind of the product and computed by the product registration apparatus, and
computing the first product quantity by regarding, as the first object, the product having the first population quantity greater than a maximum value of the second population quantity.

11. The product quantity determination apparatus according to claim 7, wherein the operations comprise
computing a first population quantity being a quantity of the products by kind of the product,
acquiring a second population quantity being a quantity of the products by kind of the product and computed by the product registration apparatus, and,
at a time at which the first product quantity is computed,
when for any second population quantity, a kind of a first product having the second population quantity is fewer than a kind of a second product having the first population quantity same as the second population quantity, subtracting, from a quantity of products detected by the detection processing, a value acquired by multiplying a difference in number between the kind of the first product and the kind of the second product by the second population quantity.

12. The product quantity determination apparatus according to claim 1, wherein the operations comprise,
when a plurality of products are detected in at least one of the images, determining the first object by deciding whether each of the plurality of products is detected in the other image.

13. A product quantity determination method comprising,
by a computer:
acquiring a plurality of images including, in a capturing range, a target region being a region where a product may be disposed;
performing detection processing of a product on each of the plurality of images; and
determining a first object being a product detected in a predetermined number or more of the images in the detection processing, and setting, as a first product quantity being a quantity of products to be paid for, a quantity acquired by excluding the first object from products detected by the detection processing.

14. A non-transitory computer-readable storage medium storing a program causing a computer to perform operations comprising:
acquiring a plurality of images including, in a capturing range, a target region being a region where a product may be disposed;
performing detection processing of a product on each of the plurality of images; and
determining a first object being a product detected in a predetermined number or more of the images in the detection processing, and setting, as a first product quantity being a quantity of products to be paid for, a quantity acquired by excluding the first object from products detected by the detection processing.
